(19) United States
(12) Patent Application Publication
(10) Pub. No.: US 2022/0121896 A1
(43) Pub. Date: Apr. 21, 2022

(54) CHIP CARD

(71) Applicant: SKIDATA GmbH, Grodig/Salzburg (AT)

(72) Inventors: Josef IRLINGER, Grodig/Salzburg (AT); Robert WOLNY, Kematen in Tirol (AT); Benedikt GSCHOSSMANN, Grodig/Salzburg (AT); Wolfgang WASMEIER, Grodig/Salzburg (AT)

(21) Appl. No.: 17/502,425

(22) Filed: Oct. 15, 2021

(30) Foreign Application Priority Data
Oct. 15, 2020 (DE) 10 2020 127 160.3

(51) Int. Cl. G06K 19/077

(52) U.S. Cl. CPC G06K 19/07722

(57) ABSTRACT

A chip card (1) is provided, comprising a chip (9), which is realized as a laminar composite, the visible sides (2) of which are realized as layers made from wood veneer. A core, which is realized as prelaminate (3), is arranged between the visible sides (2) and the core has a paper substrate (4) connected on both sides to a layer (5) made from paper or cardboard. The chip (9) and, if present, an antenna (10) are arranged on the paper substrate.

This application claims priority from German patent application serial no. 10 2020 127 160.3 filed Oct. 15, 2020.

### FIELD OF THE INVENTION

The present invention relates to a chip card as claimed in the independent claim(s).

### BACKGROUND OF THE INVENTION

According to the prior art, chip cards are often used as data carriers, for example in the form of credit cards, identity cards, access, money or contactless smart cards. They comprise a chip, which generally has an integrated circuit, storage means and further electronic components, and depending on the respective use, an antenna connected to the chip.

It is known from the prior art to produce cards of this type from plastic materials, particularly PVC or PET, wherein a chip and if appropriate an antenna are installed into these cards.

### SUMMARY OF THE INVENTION

With regards to the need to reduce the use of plastic materials, it is the object of the present invention to specify a chip card which is produced predominantly from natural renewable materials and is extremely robust and nonetheless flexible.

This object is achieved by the features of the independent claim(s). Further embodiments and advantages emerge from the dependent claims.

Accordingly, a chip card is suggested, comprising a chip, which is realized as a laminar composite, the visible sides of which are realized as layers made from wood veneer, wherein a core, which is realized as prelaminate, is arranged between the visible sides, which core has a paper substrate connected on both sides to a layer made from paper or cardboard in each case, on which paper substrate the chip and, if present, an antenna of the chip card are arranged.

According to a development of the invention, an intermediate layer made from a non-woven fabric is provided between the prelaminate and the respective visible side of the chip card, which is produced from wood veneer.

The layers of the chip card according to the invention are preferably adhesively bonded to one another.

The prelaminate accordingly has a paper substrate, on which the chip is arranged and which is arranged between two layers made from paper or cardboard and adhesively bonded to the same. In the event that the chip card has an antenna, the antenna and the chip are preferably arranged as one unit on the substrate.

The construction of the chip card according to the invention advantageously results in a stabilizing effect; the chip card is extremely robust and nonetheless flexible.

According to a particularly advantageous embodiment of the invention, it is provided that one of the layers made from paper and/or cardboard of the prelaminate is realized as a passepartout, in which a recess is punched out, which accommodates the chip arranged on the paper substrate. In the event that the chip card has an antenna, the same is arranged on the paper substrate. This embodiment achieves the advantage that the thickness of the chip card can be kept low and uniform for a high robustness. Furthermore, the service life of the card is increased by minimizing chip or contact breaks.

According to further embodiments of the invention, a thermally printable lacquer can be applied entirely or partially on the wood veneer of a visible side or both visible sides of the chip card, in order to enable printing on the chip card.

The chip card according to the invention can be used everywhere where chip cards realized according to the prior art are used; for example, a chip card according to the invention can be realized as a passive RFID or NFC chip card, as a money card, as an access card, identity card or as a credit card.

### BRIEF DESCRIPTION OF THE DRAWINGS

The invention is explained in more detail by way of example in the following on the basis of the attached figures. In the figures:

FIG. 1: shows a schematic exploded view to show the general construction of a chip card according to the invention;

FIG. 2: shows a schematic exploded sectional view to show the construction of a chip card according to an embodiment of the invention; and

FIG. 3: shows a schematic exploded sectional view to show the construction of the prelaminate of the chip card according to FIG. 2.

### DETAILED DESCRIPTION OF THE PREFERRED EMBODIMENTS

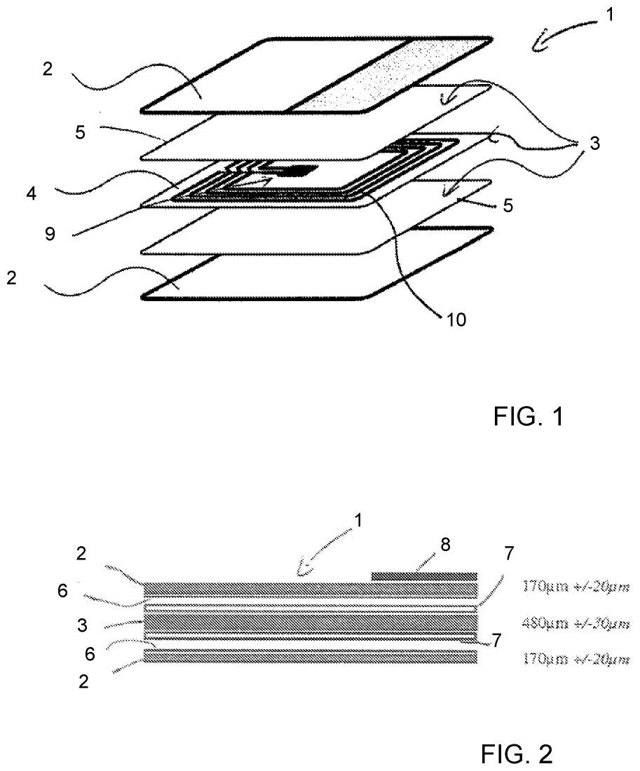

According to the invention and taking account of FIG. 1, a chip card 1 according to the invention is realized as a laminar composite, wherein the visible sides 2 of the chip card 1 are constructed as layers from wood veneer. For example, the wood veneer can be produced from cherry wood. As can be drawn from FIG. 1, a core 3, which is realized as a prelaminate, is arranged between the visible sides 2, which core has a paper substrate 4 connected on both sides to a layer 5 made from paper or cardboard in each case, on which paper substrate the chip 9 of the chip card 1 and an antenna 10 are arranged. Preferably, the chip 9 and the antenna 10 are arranged as one unit on the paper substrate 4.

In the example shown in FIG. 2, an intermediate layer 6 made from non-woven fabric is provided between the prelaminate 3 and the respective visible side 2 of the chip card 1, which is produced from wood veneer; adhesive layers are labeled with the reference number 7. Furthermore, in FIG. 2, typical values of the thickness of the individual layers are specified; advantageously, the thickness of the chip card 1 corresponds in the example shown to the standard thickness of conventional chip cards realized according to the prior art.

In the example shown in FIG. 2, a thermally printable lacquer 8 is applied partially on a visible side 2 of the chip card 1, in order to enable printing on the chip card 1.

The layers of the chip card 1 are connected to one another by means of the adhesive layers 7, wherein a “quasi-lamination” is carried out under a reduced supply of heat and reduced pressure to connect layers of the chip card 1, depending on the adhesive chosen.

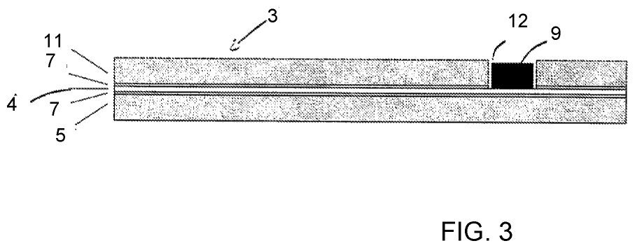

The structure of the prelaminate 3 illustrated in FIG. 2 is the subject matter of FIG. 3. Here, one of the layers made from paper and/or cardboard of the prelaminate 3 is realized as a passepartout 11, in which a recess 12 is punched out, which accommodates the chip 9 arranged on the paper substrate 4. This embodiment achieves the advantage that the thickness of the chip card 1 can be kept low and uniform without negatively impairing the achievable robustness. Due to the recess, an elevation at the chip position, which otherwise occurs, is prevented, as a result of which the chip card becomes “flatter”.

If the chip card 1 has an antenna, this is arranged on the paper substrate 4, wherein the antenna and the chip are preferably arranged as one unit on the substrate 4 and the chip 9 is accommodated in the recess 12. In FIG. 3, the adhesive layers, which are used to connect the paper substrate 4 to the passepartout 11 and the layer 5 made from paper or cardboard, are labeled with the reference number 7.

1. A chip card (1) comprising:
a chip (9),
wherein the chip card is realized as a laminar composite,
visible sides (2) of which are realized as layers made from wood veneer,
a core, which is realized as prelaminate (3), is arranged between the visible sides (2), which core has a paper substrate (4) connected on both sides to a layer (5) made from paper or cardboard in each case, on which paper substrate the chip (9) and, if present, an antenna (10) are arranged.

2. The chip card (1) according to claim 1, wherein an intermediate layer (6), made from a non-woven fabric, is provided between the prelaminate (3) and the respective visible side (2) of the chip card (1), which is produced from wood veneer.

3. The chip card (1) according to claim 1, wherein one of the layers made from paper and/or cardboard of the prelaminate (3) is realized as a passepartout (11), in which a recess (12) is punched out, which accommodates the chip (9) arranged on the paper substrate (4).

4. The chip card (1) according to claim 1, wherein the chip card (1) has an antenna (10), which is arranged on the paper substrate (4), and the antenna (10) and the chip (9) are arranged on the substrate (4) as one unit.

5. The chip card (1) according to claim 1, wherein a thermally printable lacquer is entirely or partially applied on the wood veneer of one visible side (2) or both visible sides (2) of the chip card (1), in order to enable printing on the chip card (1).

6. The chip card (1) according to claim 1, wherein the wood veneer of the visible sides (2) of the chip card (1) is produced from cherry wood.

7. The chip card (1) according to claim 1, wherein the layers of the chip card (1) are connected to one another by adhesive layers (7).

8. The chip card (1) according to claim 7, wherein, depending on the adhesive chosen, a “quasi-lamination” is carried out under a reduced supply of heat and reduced pressure to connect layers of the chip card (1).

9. The chip card (1) according to claim 1, wherein the chip card is realized as one of a passive RFID or a NFC chip card, as a money card, as an access card, as an identity card or as a credit card.
